(19) United States
(12) Patent Application Publication
(10) Pub. No.: US 2001/0013120 A1
(43) Pub. Date: Aug. 9, 2001

(54) Digital contents rental system

(75) Inventor: Yuji Tsukamoto, Tokyo (JP)

Correspondence Address: FOLEY & LARDNER, Washington Harbour, 3000 K Street, N.W., Suite 500, P. O. Box 25696, Washington, DC, 20007-8696, US

(73) Assignee: NEC CORPORATION

(21) Appl. No.: 09/771,702

(22) Filed: Jan. 30, 2001

(30) Foreign Application Priority Data
Feb. 8, 2000 (JP) 2000-030969
Dec. 14, 2000 (JP) 2000-380622

(51) Int. Cl. H04N 7/16

(52) U.S. Cl. 725/5

(57) ABSTRACT

A digital contents rental system enables images which are desired by customers to be rented in a short period of time. A user takes a recording medium to the store of the rental agent and sets it to a download apparatus. Subsequently, when a content number or the like is specified by using a keyboard of the download apparatus, the specified contents are downloaded to the recording medium, and a rental fee is calculated and displayed. The user pays the displayed fee, and carries the recording medium back to his home. When the user sets the recording medium to the adaptor and presses the start button, the contents which were downloaded to the recording medium are displayed on a display device.

### BACKGROUND OF THE INVENTION

1. Field of the Invention

The present invention relates to a digital contents rental system for feecharging rental of digital contents such as movies, televised programs, and instructional videos.

2. Description of the Related Art

Video rental stores are a widely popular system for renting media, which moving images such as movies are recorded in, to consumers, and charging fees in accordance with the rented contents or number of days rented. The recording media rented by these video rental stores comprise VHS video tapes of movies and CDs of music.

At present, there are moves toward high-definition and digitized video transmission. It is said that digitization of television broadcasts will proliferate, as in the case of BS satellite broadcasts, and there will be rapid developments in HDTV (high-definition TV) which carries six times as much information as conventional SDTV (standard TV). Movie companies, such as those in Hollywood, may be expected to resist the popularization of HDTV. However, these companies will be able to make direct use of the remarkable advances in computer graphic technology, and to cut the cost of distributing a great many films around the world. Therefore, the movie companies are welcoming broadcasts of movies by satellite digital HDTV, thereby further promoting the development of digital HDTV. In fact, transmission of movies by BS digital HDTV broadcasting has been tested in the USA, and was so successful that viewers claimed they could not distinguish the broadcasts from televised films. In addition, since digital broadcasts can transmit a far greater number of video streams than conventional aboveground wave analog broadcasts, it is only a matter of time before multiple-stream (i.e. multi-channel) digital broadcasting becomes a reality.

In view of the progress of video transmission satellite (BS) broadcasting, digitization, HDTV, and multi-channel methods described above, conventional video recording using magnetic tape and rental systems thereof have the following problems.

(1) Irrespective of the recording method, the magnetic tape contacts the magnetic head for playback and recording, inevitably damaging the quality of the image. The “rainfall” streaks seen in rental videos are a typical example of tape damage resulting from contact sliding. When HDTV has been recorded, image damage caused by deterioration of the magnetic tape is a fatal product flaw for viewers (consumers).

(2) At present, dubbing (copying) of images by individuals using magnetic tape media is tacitly permitted, and illegal copying is freely and widely carried out. Since HDTV programs are costly to produce and require expensive equipment, it would be disastrous for program producers and managers if copying of HDTV was permitted in the conventional way. Therefore, there is a demand for a new method of supplying video rental stores which would strictly control copying.

(3) An optical disk is a common example of a removable medium, but does not have a bit rate which is adequate to record HDTV at a bit rate of 18 to 24 Mbps and cannot record high-definition HDTV images in a complete format.

(4) With advancements in multi-channel broadcasting, there are multiple programs on other channels which viewers wish to view, and it may not be possible to record these programs. Furthermore, it will become possible to transmit moving images shot from multiple angles in the same program. Transmission of moving images from multiple angles is most effective for sports programs, in which scenes of point-scoring and knockouts are filmed from multiple angles and transmitted. In most households, it will not be possible to record such transmitted images, and consequently there will be an even greater demand to rent specialist recordings of the images. However, conventional rental systems have a drawback in that they only permit rental of video tapes which have been prepared beforehand, and cannot offer rapid same-day or next-day rental of television programs.

As described above, digital, HDTV, and multi-channel transmission are central elements of BS digital broadcasting, which is expected to proliferate rapidly in the near future, but cannot be handed by conventional video rental stores which use a magnetic tape as the recording medium.

### SUMMARY OF THE INVENTION

The present invention has been realized in consideration of the problems described above. It is an object of this invention to provide a digital contents rental system which allows short-term rental of images desired by customers. It is another object of this invention to provide a digital contents rental system which can prevent illegal copying. It is yet another object of this invention to provide a digital contents rental system which can provide high-quality images with extremely low deterioration.

The present invention has been achieved in order to solve the problems described above. A first aspect of this invention provides a digital contents rental system comprising a portable recording medium which contents are stored in, and a download apparatus which is managed by a rental agent and has an internal storage unit, which a plurality of contents are stored in beforehand. The download apparatus downloads the internal contents to the recording medium in compliance with a command from a user or a staff member. An adaptor reads the contents stored in the recording medium and outputs them to a display device. The adaptor is provided at the user's home.

A second aspect of this invention provides the digital contents rental system of the first aspect of this invention, wherein the download apparatus writes a rental period in the recording medium in compliance with a command from the user or a staff member. The adaptor prohibits output outside the rental period when outputting the contents stored in the recording medium to the display device.

A third aspect of this invention provides the digital contents rental system of the first and second aspects, wherein the download apparatus writes a number of permissible copies in the recording medium in compliance with a command from the user or staff member. The adaptor prohibits copies exceeding the number of permissible copies when copying the contents stored in the recording medium to an outside storage unit.

A fourth aspect of this invention provides the digital contents rental system of the second and third aspects, wherein the download apparatus calculates a rental fee for the contents in accordance with the rental period.

A fifth aspect of this invention provides the digital contents rental system of the third and fourth aspects, wherein the download apparatus calculates a rental fee for the contents in accordance with the number of permissible copies.

A sixth aspect of this invention provides the digital contents rental system of the first to fifth aspects, wherein the download apparatus calculates a rental fee in accordance with the type of contents.

A seventh aspect of this invention provides the digital contents rental system of the first to sixth aspects, wherein advertisement images are stored beforehand in the internal storage unit of the download apparatus. The download apparatus writes the advertisement images together with the contents to the recording medium.

An eighth aspect of this invention provides the digital contents rental system of the seventh aspect, wherein the download apparatus calculates the rental fee for the contents in accordance with a number of advertisement images which were written to the recording medium.

A ninth aspect of this invention provides the digital contents rental system of the first to eighth aspects, wherein the download apparatus calculates the total number of rentals of each content. The rental agent who manages the download apparatus pays a fee for using the contents to a contents supplier in compliance with the total number of rentals.

A tenth aspect of this invention provides the digital contents rental system of the third to eighth aspects, wherein the download apparatus calculates the total number of permissible copies of each content. The rental agent who manages the download apparatus pays a fee for using the contents to a contents supplier in compliance with the total number of permissible copies.

An eleventh aspect of this invention provides the digital contents rental system of the seventh and eighth aspects, wherein the download apparatus calculates the total number of times each of the advertisement images was written. The rental agent who manages the download apparatus sends an advertisement fee invoice to an advertisement image supplier in compliance with the total number of times the advertisement images were written.

A twelfth aspect of this invention provides the digital contents rental system of the first to eleventh aspects, wherein the recording medium comprises a magnetic disk apparatus.

As described above, according to this invention, the rental agent downloads contents from a download apparatus to a portable recording medium. This has the following advantages. Conventional rental systems merely rent video tapes which have been prepared beforehand in the rental store, and consequently offer an extremely limited variety of contents which nevertheless occupy considerable space, since the video tapes are laid out in the store. Furthermore, since the rental agent manufactures the video tapes and delivers them to the store by vehicle and the like, time is needed to arrange the tapes in the store. This makes it impossible to rent video tapes of television programs which were broadcast on the previous day, for example. Moreover, customers must return the tapes to the store after viewing them, which is inconvenient. In contrast, according to the rental system of this invention, the contents occupy no space at all, since they are stored in the download apparatus. As a result, a far greater variety of contents than in conventional systems can be prepared in a very small store. The contents can be transmitted to the rental store via a communication line such as the internet, enabling television programs and the like to be prepared in the rental store in an extremely short period of time. As a consequence, contents which are desired by customers can be made available for renting within an extremely short period of time. There is a further advantage that customers need not return the contents after viewing them.

According to this invention, the download apparatus writes the number of permissible copies in the recording medium in compliance with a command from the user or the store staff. When copying the contents which have been recorded in the recording medium to an outside recording unit by using an adaptor at the user's home, the user is prohibited from copying a number of copies greater than the number of permissible copies. Therefore, illegal copying can be prevented.

According to this invention, the recording medium comprises a magnetic disk apparatus. Therefore, high-definition images can be provided with extremely low deterioration.

### BRIEF DESCRIPTION OF THE DRAWINGS

FIG. 1 is a block diagram showing the main constitution of a digital contents rental system according to an embodiment of this invention.

FIG. 2 is a block diagram showing the constitution of a download apparatus 1 in the same embodiment.

FIG. 3 is a diagram showing contents stored in the memory of a recording medium 2 in the same embodiment.

FIG. 4 is a block diagram showing the constitution of an adaptor 3 in the same embodiment.

FIG. 5 is a block diagram showing the constitution of the rental agent side in the same embodiment.

FIGS. 6A and 6B are diagrams showing examples of fee tables in the same embodiment.

FIGS. 7A and 7B are diagrams showing examples of fee tables in the same embodiment.

FIGS. 8A and 8B are diagrams showing examples of rental records and advertisement records in the same embodiment.

### DESCRIPTION OF THE PREFERRED EMBODIMENT

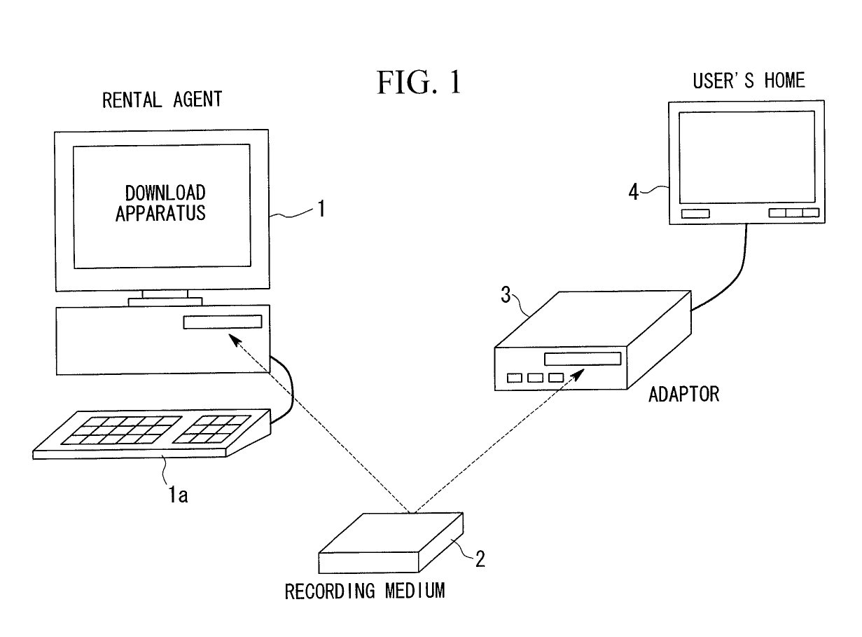

A preferred embodiment of this invention will be explained with reference to the drawings. FIG. 1 shows the schematic constitution of the digital contents rental system according to an embodiment of this invention. In FIG. 1, reference code 1 represents a download apparatus which is provided in the store of a rental agent. Reference code 2 represents a recording medium. The download apparatus 1 sets the recording medium 2 and downloads thereto digital contents of movies and the like, which are stored in a memory apparatus of the download apparatus 1. The recording medium 2 comprises, for example, a portable and removable magnetic disk. Reference code 3 represents an adaptor which is provided in a user's home. The adaptor 3 reads the digital contents which are downloaded to the recording medium 2 when the recording medium 2 is set, and displays the digital contents on a display device 4 such as a television.

The basic operation of the system is as follows. The user takes the recording medium 2 to the store of the rental agent and sets it to the download apparatus 1. Subsequently, when a content number or the like is specified by using the keyboard 1 a of the download apparatus 1, the specified content is downloaded to the recording medium 2, and the rental fee is calculated and displayed. The user pays the displayed fee, and carries the recording medium 2 to his home. When the user sets the recording medium 2 to the adaptor 3 and presses the start button, the contents which were downloaded to the recording medium 2 are displayed on the display device 4.

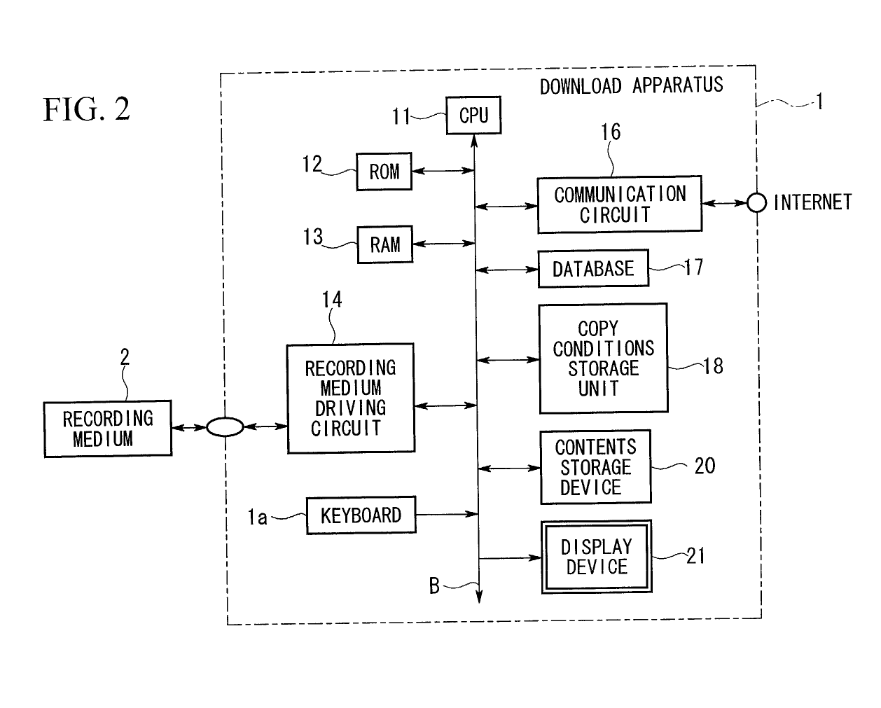

FIG. 2 is a block diagram showing the constitution of the download apparatus 1. In FIG. 2, reference code 11 represents a CPU (central processing unit) which controls all sections of the apparatus, reference code 12 represents an ROM (read-only memory) which programs of the CPU 11 are stored in, and reference code 13 represents an RAM (random access memory) for temporary data storage. Reference code 14 represents a recording medium driving circuit which reads and writes data from/to the recording medium 2. Reference code 16 represents a communication circuit which controls data communication between the CPU 11 and the internet. Reference code 17 represents a database which data, such as fees, are stored in beforehand, and reference code 18 represents a copy conditions storage unit which copy conditions are stored in. The database 17 and the copy conditions storage unit 18 comprise a single memory apparatus. Reference code 20 represents a large-capacity contents storage device which a great number of contents are stored in, and for example comprises a large-scale magnetic disk apparatus. Reference code 21 represents a display device.

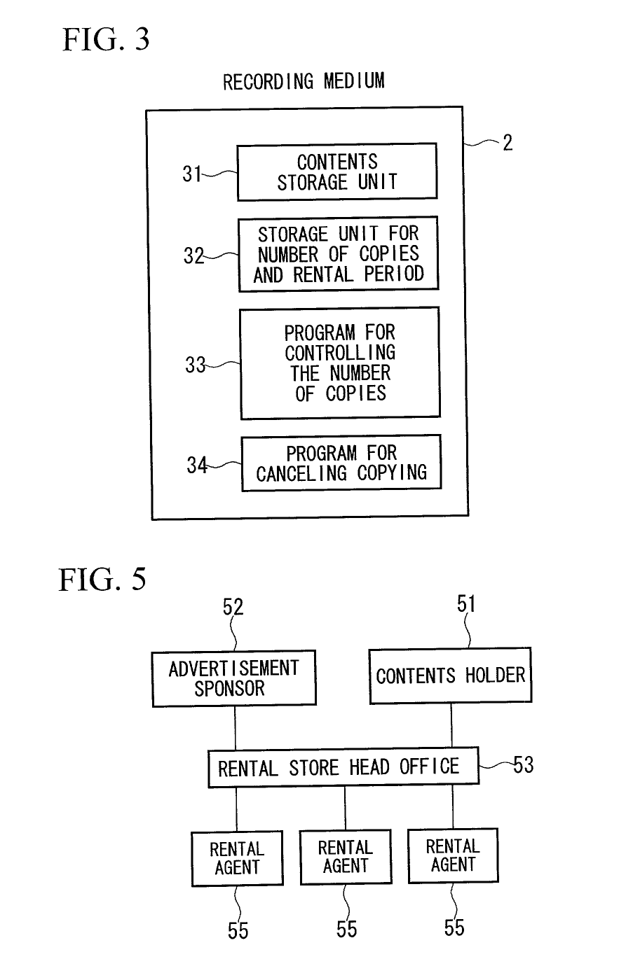

FIG. 3 is a diagram showing a memory area of the recording medium 2. As shown in FIG. 3, the recording medium 2 comprises a contents memory section 31 which the contents are stored in, a memory section 32 which the number of copies allowed by the user, the number of copies made by the user, and the rental period are stored in, a memory section 33 which a copy number control program for checking the number of copies made by the user is stored in, and a memory section 34 which a copy cancel program is stored in.

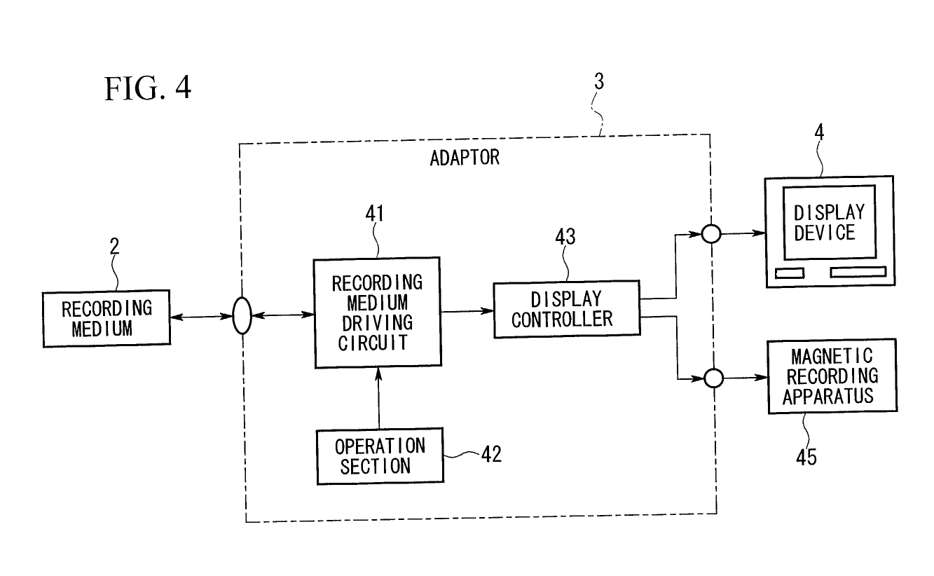

FIG. 4 is a block diagram showing the constitution of the adaptor 3 provided in the user's home. In FIG. 4, reference code 41 represents a recording medium driving unit which reads and writes programs from/to the recording medium 2 and controls the adaptor 3 based on the programs read from the recording medium 2. Reference code 42 represents an operation section comprising a start switch and the like. Reference code 43 represents a display controller which expands contents (normally compressed) which have been read from the recording medium 2 to their pre-compressed state, converts them to an analog video signal, and outputs this signal to the display device 4. The contents which have been read from the recording medium 2 are written to a magnetic recording apparatus 45 such as an external hard disk. The contents may be written to an optical disk instead of to the magnetic recording apparatus 45.

FIG. 5 is a block diagram showing the constitution of the rental agent side. In FIG. 5, reference code 51 represents a contents holder such as a movie distribution company, and reference code 52 represents an advertisement sponsor such as an advertisement office. Reference code 53 represents a rental store head office which is connected to the contents holder 51 and the advertisement sponsor 52 via a communication network such as the internet. Reference code 55 represent rental agents which are connected to the rental store head office 53 via the internet.

Subsequently, the operation of the abovementioned digital contents rental system will be explained.

Firstly, the rental store head office 53 makes a contents rental contract with the contents holder 51. The contract specifies the content number, the fee, the number of permissible copies, etc. The contents holder 51 transmits the contracted contents via a communication line to the rental store head office 53. The rental store head office 53 writes the contents, transmitted from the contents holder 51, in an internal memory apparatus. In the case where there is a separate organization for managing copyright of the contents, a contract is made simultaneously with that organization.

The rental store head office 53 makes a contract with the advertisement sponsor 52. This contract determines the type of advertisement image data, the fee to be paid by the advertisement sponsor 52, etc. The advertisement sponsor 52 transmits the contracted advertisement image data via a communication line to the rental store head office 53. The rental store head office 53 writes the advertisement image data, transmitted from the advertisement sponsor 52 in an internal memory apparatus.

Subsequently, the rental store head office 53 transmits the contents and advertisement image data via the internet to the rental agents 55. The transmitted data are written in a contents storage device 20 of the download apparatus 1 of each rental agent 55. The rental store head office 53 transmits programs for controlling the number of copies and canceling copying to the rental agents 55. The programs are written in the copy conditions storage unit 18 of the download apparatus 1.

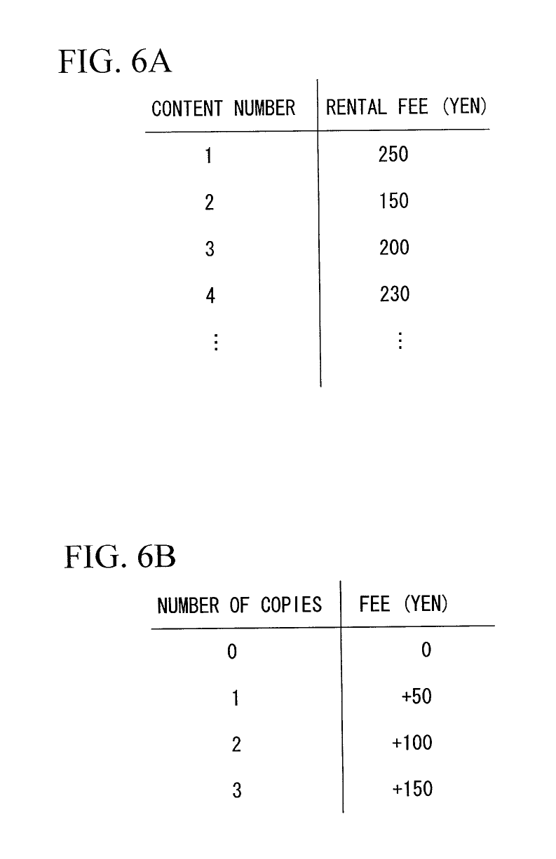

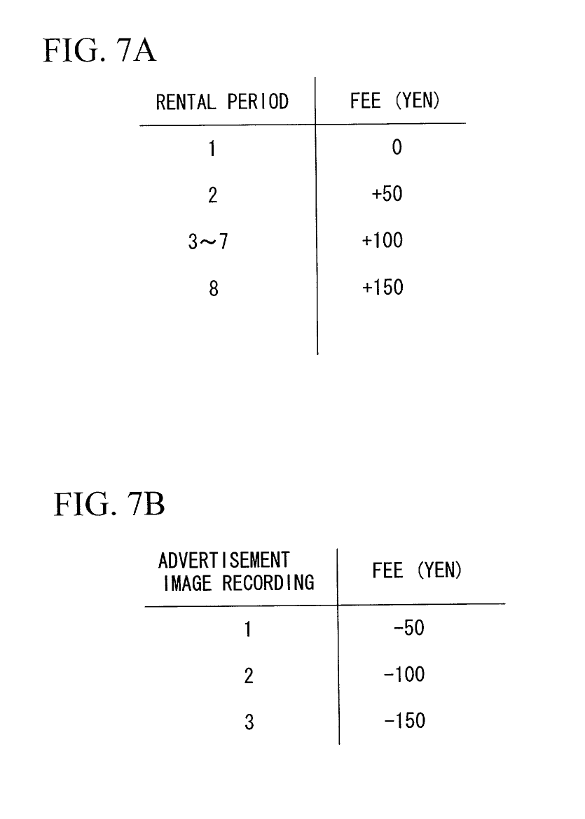

Then, the rental store head office 53 transmits fee tables to the rental agents 55. The transmitted fee tables are written in the database 17 of the download apparatus 1. FIGS. 6A, 6B, 7A, and 7B show examples of the fee tables. FIG. 6A is a table showing the corresponding relationship between the content numbers and basic rental fees for those contents. FIG. 6B is a table showing the corresponding relationship between the copy numbers, which specify the number of permissible copies, and an additional fee, which is added to the rental fee. For example, copy number “2” and “+100 Yen” signifies that when the user is permitted two copies, the rental fee becomes

Basic rental fee+100 Yen.

FIG. 7A shows the corresponding relationship between the rental period and additional fees. For example, when the rental period is one day, the fee is only the basic rental fee shown in FIGS. 6A and 6B, but in the case of two days, the fee becomes

Basic rental fee+50 Yen.

FIG. 7B is a table showing the corresponding relationship between the advertisement image records and fee reductions. When downloading the contents to the recording medium 2, in the case where the user has allowed recording of one advertisement image data, the rental fee is

Basic rental fee−50 Yen.

When the user has allowed recording of two advertisement image data, the rental fee becomes

Basic rental fee−100 Yen.

The above processing is performed prior to opening the rental store, when changing and adding contents, and when changing the fees.

Subsequently, the operation when renting contents will be explained. A user who wishes to rent a content takes the recording medium 2, which he has purchased in advance, to the rental agent 55. Users who do not have a recording medium 2 may purchase one at the rental store. The user sets his recording medium 2 to the download apparatus 1. In compliance with the instructions of the store staff, the user manipulates the keyboard 1a to display a list of the contents on the display screen of the display device 21. When the user selects the contents he desires from among those displayed on the screen, the CPU 11 (FIG. 2) detects the selection, reads the selected contents from the content memory storage device 20, and outputs them to the recording medium driving circuit 14. The recording medium driving circuit 14 sequentially writes the contents to the contents storage section 31 (FIG. 3) of the recording medium 2.

The CPU 11 reads the programs for controlling the number of copies and canceling copying from the copy conditions storage unit 18, and outputs the programs to the recording medium driving circuit 14. The recording medium driving circuit 14 writes the programs respectively to the memory sections 33 and 34 of the recording medium 2. The CPU 11 displays a screen for selecting the number of copies, the rental period, and the number of advertisement image recordings on the screen of the display device 21. The user inputs the number of copies, the rental period, and the number of advertisement image recordings, to this screen. The CPU 11 writes the input number of copies and rental period via the recording to the memory section 32 of the recording medium 2. Then, the CPU 11 calculates the fee by consulting the tables showing the number of advertisement image recordings, number of copies, rental period, and numbers of the contents which have been written in the recording medium 2. The fee is displayed on the display device 21. The user pays the fee to the store staff, and takes home the recording medium 2.

When the contents holder 51 has specified a maximum number of copies, the maximum is stored in the database 17 and only numbers of copies up to this maximum are permitted.

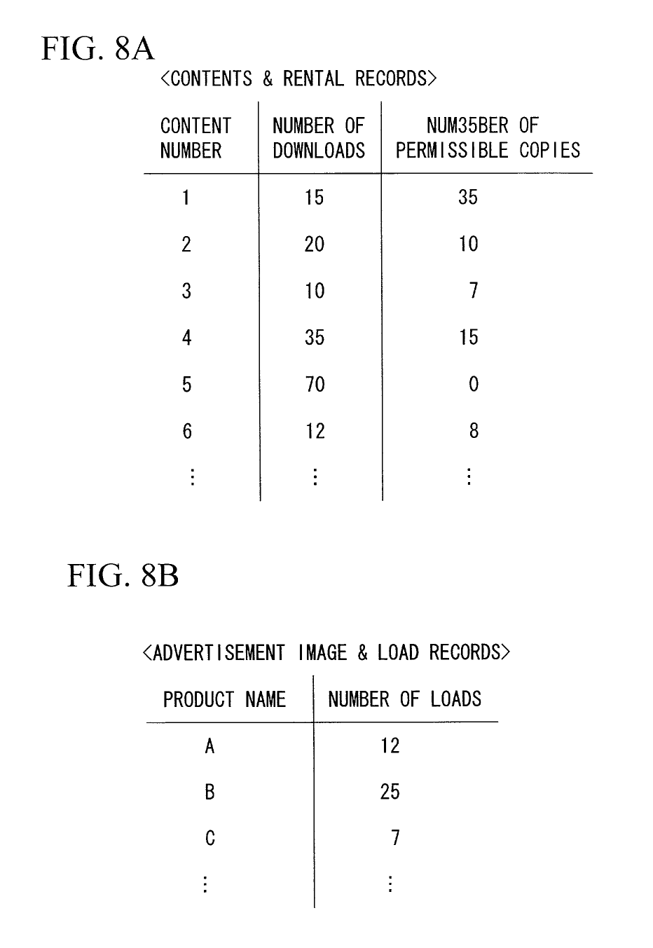

The CPU 11 creates a rental record in the database 17. FIGS. 8A and 8B show an example of the rental record. FIG. 8A shows totals of the numbers of downloads and the numbers of permissible copies, and FIG. 8B shows totals of the numbers of downloaded advertisement images. For example, when the content having content number “3” is rented with two permissible copies, the advertisement images of products A and C are downloaded together with the content. The CPU 11 adds “1” to the number of downloads of the content number “3” in the table of FIG. 8A, and adds “2” to the number of copies. Then, the CPU 11 adds “1” to the load numbers of products A and B in the table of FIG. 8B.

This completes the processing of the download apparatus 1.

Subsequently, the processing of the adaptor 3 (FIG. 4) will be explained. When the user returns home, sets the recording medium 2 to the adaptor 3, and presses the start button, the recording medium driving circuit 41 reads the rental period from the memory section 32 of the recording medium 2 and determines whether the present time is within the rental period. When the present time is within the rental period, the recording medium driving circuit 41 reads the content from the memory section 31 of the recording medium 2 and outputs it to the display controller 43. The display controller 43 expands the content, converts it to an analog signal, and outputs the signal to the display device 4. Consequently, the content of the recording medium 2 is displayed by the display device 4.

On the other hand, when the present time is outside the rental period, the recording medium driving circuit 41 does not read the content of the recording medium 2.

Subsequently, when the user presses the copy button of the operation section 42 in order to copy the content of the recording medium 2 to the magnetic recording apparatus 45, the recording medium driving device 41 reads the programs for controlling the number of copies and canceling copying from the memory sections 33 and 34, and writes them in internal memory. Then, the recording medium driving circuit 41 reads the number of copies permitted for the user and the number of copies made by the user from the copy number memory section 32, and writes them in memory. In compliance with the program for controlling the number of copies, it is determined whether the number of copies made by the user is less than the number of copies permitted for the user. When the number of copies made is less than the number of copies permitted, the recording medium driving circuit 41 reads the contents from the contents memory section 31, and writes them in the magnetic recording apparatus 45 via the display controller 43. The recording medium driving circuit 41 adds “1” to the number of copies made by the user, which is stored in the copy number memory section 32. On the other hand, when the number of copies made equals or exceeds the number of copies permitted, the program for canceling copying is activated and copying is cancelled.

Therefore, the user is only able to make a number of copies which is within the number specified in his contract with the rental store.

Subsequently, monthly payment of fees advertisement invoices will be explained. As described above, the download apparatus 1 of each rental agent 55 creates the tables shown in FIGS. 8A and 8B for each of the contents rented by the user. The tables of 8A and 8B are transmitted to the rental store head office 53 on a specified day each month. The rental store head office 53 calculates a total of the tables 8A and 8B transmitted from the rental agents 55, and calculates the total numbers of downloads and permitted copies. The rental store head office 53 also calculates a total number of downloads for each product. A contents fee is calculated based on the calculated total numbers of downloads and permitted copies, and payment is sent to the contents holder 51. An advertisement fee is calculated based on the total number of downloads for each product, and an invoice is sent to the advertisement sponsor 52.

Subsequently, advantages of the rental system according to the above embodiment will be explained.

The system provides a system for renting image information which is compatible with digital, HDTV, and multi-channel transmission of images by using BS digital broadcasts which will rapidly proliferate in the future, and has the following advantages.

(1) The system can provide the customer with high-definition images, such as HDTV, in a viewing format of his choice (with or without advertisements, number of copies) and for a period of his choice, with no deterioration in image quality.

(2) Suppliers who hold copyright of the contents and organizations which manage copyright can receive payment based on accurately managed information. In addition to being able to draft invoices for advertisements in a single process, the advertisement sponsors can obtain real-time information relating to what consumers want.

(3) Since the recording medium 2 for the contents can be carried, it is possible to provide the consumer with high-definition images such as HDTV which do not suffer image deterioration as do conventional magnetic tapes. It is difficult to directly record HDTV onto an optical disk due to the limited bit rate.

(4) The number of copies desired by the customer and the number of copies permitted by the copyright holder are recorded on the recording medium. Therefore, illegal copying, which is tacitly allowed at present, can be prevented. In addition, the number of copies can be quantitatively assessed, enabling payment of copyright fees to copyright organizations to be made smoothly.

(5) A contract can be made with the supplier who holds the copyright for the contents, and copyright organizations, in a single process. Therefore, collection and payment of fees for usage can be made smooth. As a consequence, the contents supplier can reduce the risk of manufacturing HDTV images, and obtain stable viewing fees from regions other than the live broadcast region, thereby making management of the system stable. This benefits the promotion of HDTV, which is costly and requires expensive equipment.

(6) The system allows market rental of video information which is compatible with multi-channel broadcasting.

The digital contents rental system according to the embodiment of this invention has been explained in detail.

In the above embodiment, the recording medium 2 may comprise only the memory sections as mentioned above, or a magnetic disk apparatus comprising a write/read circuit and a disk driver in its memory section. An image display apparatus may also be provided to obtain a portable magnetic disk apparatus which allows images to be reproduced while moving.

In the embodiment described above, the recording medium 2 belonged to the customer. Alternatively, the recording medium 2 may belong to the rental agent 55, as is the case with conventional video tapes, and the customer can borrow the recording medium 2 from the rental agent 55. In this case, the rental agent 55 makes a contract with the customer to specify how the recording medium 2 which is to be rented, and the image information recorded therein, may be used. When the customer disobeys the stipulations of the contract made with the rental store at the time of renting, and when the information recorded in the recording medium 2 is lost as a result of the customer's carelessness, the customer incurs a penalty fee which is set in stages according to the contract with the rental agent.

What is claimed is:

1. A digital contents rental system comprising:
a portable recording medium which contents are stored in;
a download apparatus which is managed by a rental agent and has an internal storage unit, which a plurality of contents are stored in beforehand, the download apparatus downloading the internal contents to said recording medium in compliance with a command from a user or a staff member; and
an adaptor which reads the contents stored in said recording medium and outputs them to a display device, the adaptor being provided at the user's home.

2. The digital contents rental system as described in claim 1, wherein said download apparatus writes a rental period in said recording medium in compliance with a command from said user or staff member; and
said adaptor prohibits output outside said rental period when outputting the contents stored in said recording medium to said display device.

3. The digital contents rental system as described in claims 1, wherein said download apparatus writes a number of permissible copies in said recording medium in compliance with a command from said user or staff member; and
said adaptor prohibits copies exceeding the number of permissible copies when copying the contents stored in said recording medium to an outside storage unit.

4. The digital contents rental system as described in claims 2, wherein said download apparatus calculates a rental fee for the contents in accordance with said rental period.

5. The digital contents rental system as described in claims 3, wherein said download apparatus calculates a rental fee for the contents in accordance with said number of permissible copies.

6. The digital contents rental system as described in claim 1, wherein said download apparatus calculates a rental fee in accordance with the type of contents.

7. The digital contents rental system as described in claim 1, wherein advertisement images are stored beforehand in said internal storage unit of said download apparatus, and said download apparatus writes said advertisement images together with the contents to said recording medium.

8. The digital contents rental system as described in claim 7, wherein said download apparatus calculates the rental fee for the contents in accordance with the number of advertisement images which were written to said recording medium.

9. The digital contents rental system as described in claim 1, wherein said download apparatus calculates the total number of rentals of each content, and the rental agent who manages said download apparatus pays a fee for using the contents to a contents supplier in compliance with said total number of rentals.

10. The digital contents rental system as described in claims 3, wherein said download apparatus calculates the total number of permissible copies of each content, and the rental agent who manages said download apparatus pays a fee for using the contents to a contents supplier in compliance with said total number of permissible copies.

11. The digital contents rental system as described in claims 7, wherein said download apparatus calculates the total number of times each of said advertisement images was written, and the rental agent who manages said download apparatus sends an advertisement fee invoice to an advertisement image supplier in compliance with said total number of times said advertisement images was written.

12. The digital contents rental system as described in claim 1, wherein said recording medium comprises a magnetic disk apparatus.
